(19) United States
(12) Patent Application Publication
(10) Pub. No.: US 2006/0250625 A1
(43) Pub. Date: Nov. 9, 2006

(54) Method and apparatus for adjusting display colors of a projector

(76) Inventor: Hung-Chieh Huang, Chu-Nan (TW)

Correspondence Address: J.C. Patents, Inc., Suite 250, 4 Venture, Irvine, CA, 92618, US

(21) Appl. No.: 11/405,044

(22) Filed: Apr. 17, 2006

(30) Foreign Application Priority Data
May 3, 2005 (TW) 94114198

(51) Int. Cl. H04N 1/60

(52) U.S. Cl. 358/1.9; 358/518

(57) ABSTRACT

A method and an apparatus for adjusting the display colors of a projector are provided. The method comprises the following steps. First, a pivot color point is selected on a plane area within a color space. Then, the color coordinate adjustment (CCA) technique is used to adjust the display color temperature of a projector according to the pivot color point.

### CROSS-REFERENCE TO RELATED APPLICATION

This application claims the priority benefit of Taiwan application serial no. 94114198, May 3, 2005. All disclosure of the Taiwan application is incorporated herein by reference.

### BACKGROUND OF THE INVENTION

1. Field of the Invention

The present invention relates to a method and an apparatus for adjusting display colors. More particularly, the present invention relates to a method and an apparatus that utilize the color coordinate adjustment (CCA) technique for adjusting the display colors of a projector.

2. Description of the Related Art

Variations in color temperature can give out different visual perceptions. For example, people tend to harbor a warm feeling when viewing objects in a low color temperature, while they tend to experience a cool feeling when viewing objects in a high color temperature. Therefore, projectors are often provided with a color temperature adjusting mechanism to deliver different visual effects for occasions such as an analytical conference briefing (high temperature, cool feeling) or an inspirational movie presentation (low temperature, warm feeling.)

At present, most projectors with color temperature adjusting capability are provided with a few preset color temperature values so that users can select one of the preset values to adjust the color temperature of a projector. However, the color temperature adjustment range is constrained by the preset color temperature values. Hence, not only is the color temperature adjustment range limited, but the micro-adjustment of the color temperature is not possible. In an alternative color temperature adjusting method, the ratios between red light, green light and blue light in white light are adjusted to change the color temperature. Yet, without any chromatic meter for measuring the color temperature values or without any objective data as a reference, a user can not determine the color temperature exactly but must rely on guesswork or intuition to provide the adjustment. As a result, the color temperature may differ according to individual's subjective feeling when performing the adjustment. Hence, one of the objectives of the present invention is to provide an improved method of adjusting the display color temperature.

### SUMMARY OF THE INVENTION

Accordingly, one objective of the present invention is to provide a method and an apparatus for adjusting the display colors of a projector so that a user is provided with a wider range of color temperature adjustments, objective data and auxiliary color points as a reference to improve the accuracy of color temperature adjustment.

Another objective of the present invention is to provide a method for adjusting the display colors of a projector that utilizes a color coordinate adjustment (CCA) technique.

To achieve these and other advantages and in accordance with the purpose of the invention, as embodied and broadly described herein, the invention provides a method for adjusting the display colors of a projector comprising the following steps. First, a pivot color point is selected on a plane area within a color space. Then, a color coordinate adjustment (CCA) technique is used to adjust the display color temperature of a projector according to the pivot color point.

The aforesaid plane area is a portion of the chromaticity diagram of the Commission Internationale de l'Eclairage (CIE).

The aforesaid projector is a digital light processing (DLP) projector.

In one embodiment of the aforesaid method of adjusting the display color of the projector, the pivot color point indicates a white display color.

In one embodiment of the aforesaid method of adjusting the display color of the projector, auxiliary lines, coordinate values of the plane area, and auxiliary color points including a first auxiliary color point, a second auxiliary color point and a third auxiliary color point are provided to serve as a reference for selecting the pivot color points.

The present invention also provides an apparatus for adjusting the display color of a projector. The apparatus comprises an input unit and an adjustment unit. The input unit displays a plane area within a color space so that a user can select a pivot color point from the plane area. The adjustment unit utilizes a color coordinate adjustment (CCA) technique to adjust the display color temperature of the projector according to the pivot color point.

In the present invention, the pivot color point can be freely selected from the plane area within the color space so that a wider color temperature range is provided. Furthermore, the present invention also provides auxiliary lines, coordinate values of the plane area, and auxiliary color points including the first auxiliary color point, the second auxiliary color point and the third auxiliary color point to serve as a reference for selecting the pivot color point. Hence, the overall accuracy of color temperature adjustment is improved.

It is to be understood that both the foregoing general description and the following detailed description are exemplary, and are intended to provide further explanation of the invention as claimed.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a diagram showing the color temperature range for adjusting the display color of a projector according to one embodiment of the present invention.

FIG. 2 is a diagram showing a user interface for adjusting the display color of a projector according to one embodiment of the present invention.

FIG. 3 is a flow chart showing the steps for adjusting the display color of a projector according to one embodiment of the present invention.

### DESCRIPTION OF THE EMBODIMENTS

Reference will now be made in detail to the present embodiments of the invention, examples of which are illustrated in the accompanying drawings. Wherever possible, the same reference numbers are used in the drawings and the description to refer to the same or like parts.

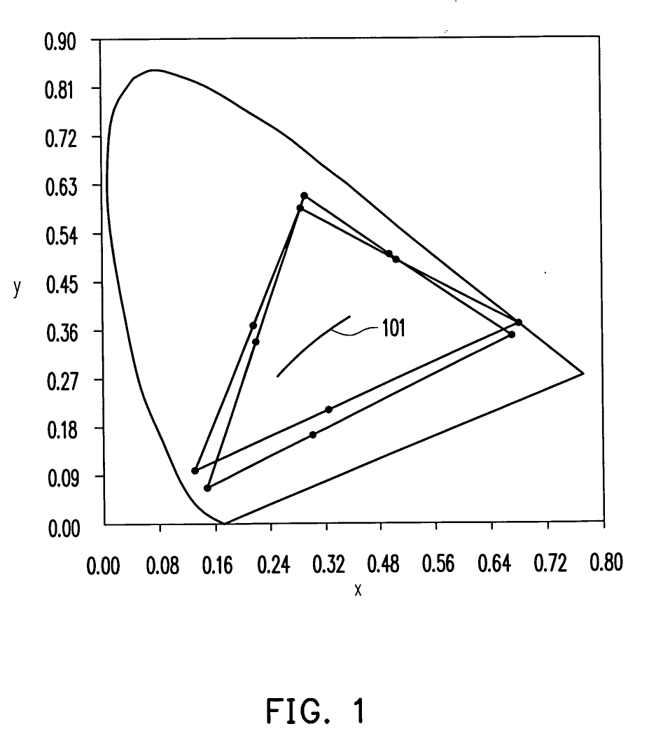

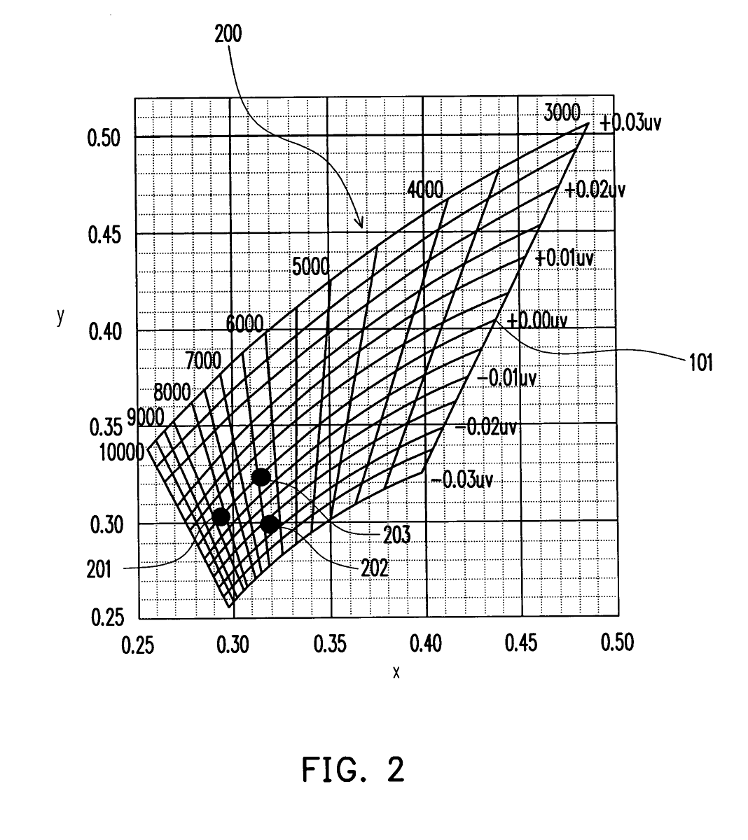

In the following embodiment, a method for adjusting the display color of a projector is illustrated with reference to FIGS. 1 and 2.

The present invention uses a color coordinate adjustment (CCA) technique to adjust the display color temperature of the projector. In the present embodiment, the projector is a digital light processing (DLP) projector. The first step in the present embodiment is to select a pivot color point from a plane area inside a color space corresponding to the user interfaces of the projector. The plane area is a portion of a certain plane of a CIE color space used in the present embodiment or a portion of a projected plane on another plane. For example, in the present embodiment, the aforesaid plane area is one portion of a projection of the x+y+z=1 plane within the CIE color space on the (x, y) plane. More precisely speaking, it is one portion of the CIE chromaticity diagram. Therefore, each point represents a color within the plane area, and the entire plane area is the result of the color points assembly.

The pivot color point selected in the aforesaid step indicates the white display color of the projector in the present embodiment. After the pivot color point is selected, the next step is to use the color coordinate technique; that is, according to the pivot color point or the relationship between the pivot color point and the display color, the display color temperature of the projector is adjusted so that the display color temperature of the projector is adjusted to a color temperature corresponding to the pivot color point. For example, selecting a color with a pivot color point close to blue makes the entire projected picture appear blue, and selecting a color with a pivot color point close to red makes the entire projected picture appear red. In the present embodiment, the color coordinate adjustment is controlled through a chip made by Texas Instrument. However, the pivot color point is not limited to a white display color in the present invention. Other display colors can be used, too.

The plane area of the present invention, the color temperature adjustment range, are roughly shown in FIG. 1. In the CIE chromaticity diagram, the plane area is within the area where a curved line 101 is the center. The user interface in the actual adjustment is shown in FIG. 2. The plane area in the present embodiment shown in FIG. 2 is the band area 200 enclosed by the remaining lines in FIG. 2 after the coordinate grid lines parallel to the x, y coordinate axes are removed. Obviously, other plane areas can be used in other embodiments of the present invention. For example, the plane area can be selected from other planes or other color spaces.

To provide an objective reference in the process of selecting the pivot color point, the user interface in FIG. 2 further comprises auxiliary lines such as coordinate grid lines and isothermal lines. The isothermal lines can indicate the color temperature values. The color temperature in the embodiment ranges between 3000K and 10000K, and the corresponding coordinate values are labeled on the auxiliary lines. In addition, specially labeled auxiliary color points are included. For example, a first auxiliary color point 201, a second auxiliary color point 202 and a third auxiliary color point 203 are also provided in the embodiment of the present invention. The third auxiliary color point 203 is the standard specification of National Television System Committee (NTSC), the second auxiliary color point 202 represents a color point with a lower color temperature, and the first auxiliary color point 201 represents a color point with a higher color temperature. In this way, a user can understand the relative color temperature values when selecting the pivot color point. For example, if the user favors a higher color temperature, the pivot color point can be selected from a position close to the first auxiliary color point 201. On the other hand, if the user favors a lower color temperature, the pivot color point can be selected from a position close to the second auxiliary color point 202. However, the number of auxiliary points used in the present invention is not limited to three. In fact, as many auxiliary color points as needed can be labeled to assist the user in selecting the pivot color point.

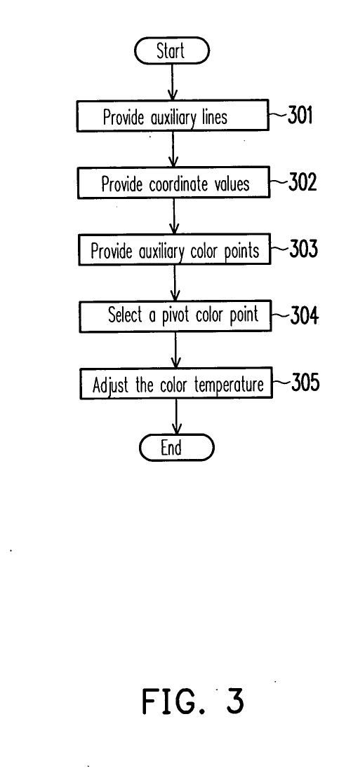

The method of the present embodiment is illustrated in FIG. 3. When the user applies the user interface of the projector, the flow chart in the present embodiment starts with step 301. First, auxiliary lines, such as the aforesaid coordinate grid and the isothermal line, are provided in step 301. In step 302, related coordinate values between the plane area and the auxiliary lines are provided. In step 303, the auxiliary color points are labeled. Thereafter, in step 304, the user selects a pivot color point. Finally, in step 305, the display color temperature of the projector is adjusted using the color coordinate adjustment (CCA) technique according to the pivot color point or the relationship between the pivot color point and the display color. Hence, the display color of the projector is adjusted to the color temperature corresponding to the pivot color point.

In other words, the pivot color point can be freely selected from the plane area within the color space in the present invention. Thus, a wider color temperate range is provided. Furthermore, by freely positioning and selecting the pivot color temperature from various locations and utilizing the color coordinate adjustment technique, micro-adjustment of the color temperature is possible. In addition, the present invention also provides auxiliary lines, coordinate values of the plane area, and auxiliary color points including the first auxiliary color point, the second auxiliary color point and the third auxiliary color point to serve as a reference for selecting the pivot color point. Hence, in the process of adjusting the color temperature, the user can objectively and accurately determine the color temperature value. Since the user does not have to rely on his or her subjective feeling to select the color temperature, the accuracy of color temperature adjustment is improved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for adjusting the display color of a projector, comprising the steps of:
selecting a pivot color point from a plane area within a color space; and
adjusting the color temperature of the projector by using a color coordinate adjustment technique according to the pivot color point.

2. The method of claim 1, wherein the projector is a digital light-processing projector.

3. The method of claim 1, wherein the color space comprises a CIE chromaticity diagram and the plane area is a portion of the CIE chromaticity diagram.

4. The method of claim 1, wherein the pivot color point comprises a white display color.

5. The method of claim 1, further comprising the step of:
providing auxiliary lines on the plane area to serve as a reference for selecting the pivot color point.

6. The method of claim 5, wherein the auxiliary lines comprise a plurality of isothermal lines, and each isothermal line represents a color temperature value.

7. The method of claim 6, wherein the isothermal lines have corresponding labeled color temperature coordinate values.

8. The method of claim 1, further comprising the step of:
providing coordinate values on the plane area to serve as a reference for selecting the pivot color point.

9. The method of claim 1, further comprising the step of:
providing at least an auxiliary color point on the plane area to serve as a reference for selecting the pivot color point.

10. The method of claim 9, wherein the color temperature values of the auxiliary color points are different.

11. The method of claim 9, wherein the auxiliary color points comprise a first auxiliary color point, a second auxiliary color point and a third auxiliary color point so that the first and the second auxiliary color points are respectively of a high color temperature and a low color temperature, and the third auxiliary color point is a color point of NTSC specification.

12. An apparatus for adjusting the display color of a projector, comprising:
an input unit for displaying a plane area within a color space so that a user can select a pivot color point from the plane area; and
an adjusting unit for adjusting the color temperature of the projector using a color coordinate adjustment technique according to the pivot color point.

13. The apparatus of claim 12, wherein the projector is a digital light-processing projector.

14. The apparatus of claim 12, wherein the color space comprises a CIE chromaticity diagram and the plane area is a portion of the CIE chromaticity diagram.

15. The apparatus of claim 12, wherein the pivot color point comprises a white display color.

16. The apparatus of claim 12, wherein the input unit further provides auxiliary lines on the plane area to serve as a reference for selecting the pivot color point.

17. The apparatus of claim 16, wherein the auxiliary lines comprise a plurality of isothermal lines and each isothermal line represents a color temperature value.

18. The apparatus of claim 17, wherein the isothermal lines have corresponding labeled color temperature coordinate values.

19. The apparatus of claim 12, wherein the input unit further provides coordinate values on the plane area to serve as a reference for selecting the pivot color point.

20. The apparatus of claim 12, wherein the input unit further provides at least an auxiliary color point on the plane area to serve as a reference for selecting the pivot color point.

21. The apparatus of claim 20, wherein the color temperature values of the auxiliary color points are different.

22. The apparatus of claim 20, wherein the auxiliary color points comprise a first auxiliary color point, a second auxiliary color point and a third auxiliary color point so that the first and the second auxiliary color points are respectively of a high color temperature and a low color temperature and the third auxiliary color point is a color point of NTSC specification.
